(19) United States
(12) Patent Application Publication
(10) Pub. No.: US 2024/0163812 A1
(43) Pub. Date: May 16, 2024

(54) METHOD FOR DETERMINING POWER ADJUSTMENT COMPONENT, TERMINAL, MEDIUM, AND CHIP

(71) Applicant: GUANGDONG OPPO MOBILE TELECOMMUNICATIONS CORP., LTD., Dongguan (CN)

(72) Inventors: Jing XU, Dongguan (CN); Yanan LIN, Dongguan (CN)

(73) Assignee: GUANGDONG OPPO MOBILE TELECOMMUNICATIONS CORP., LTD., Dongguan (CN)

(21) Appl. No.: 18/417,766

(22) Filed: Jan. 19, 2024

Related U.S. Application Data
(63) Continuation of application No. PCT/CN2021/107969, filed on Jul. 22, 2021.

(51) Int. Cl. H04W 52/36; H04W 52/14; H04W 72/21; H04W 72/566

(52) U.S. Cl. CPC H04W 52/367; H04W 52/146; H04W 72/21; H04W 72/566

(57) ABSTRACT

A method for determining a power adjustment component, a terminal, a medium, and a chip are provided. The method includes that: a terminal determines the power adjustment component of a first uplink control channel based on a first code rate, here, the first uplink control channel is used for transmitting multiple uplink control information, the multiple uplink control information corresponding to multiple code rates, and the first code rate is determined based on at least one of the multiple code rates.

### CROSS-REFERENCE TO RELATED APPLICATION(S)

This application is a continuation of International Patent Application No. PCT/CN 2021/107969 filed on Jul. 22, 2021, the entire contents of which are incorporated by reference herein in its entirety.

### BACKGROUND

In Ultra-Reliable and Low Latency Communications (URLLC), in order to ensure transmission of different Uplink Control Information (UCI), a solution that different uplink control information is transmitted separately is adopted. When there is a collision among different uplink control information, one part of the uplink control information may be transmitted while the other part of the uplink control information may be discarded.

However, this solution may cause some uplink control information not to be transmitted, thereby reducing the reliability of uplink control information transmission.

### SUMMARY

Embodiments of the disclosure relate to the field of communication technologies, and provides a method for determining a power adjustment component, a terminal, a medium, and a chip.

In a first aspect, an embodiment of the disclosure provides a method for determining a power adjustment component, which includes the following operations.

A terminal determines the power adjustment component of a first uplink control channel based on a first code rate. Here, the first uplink control channel is used for transmitting multiple uplink control information, the multiple uplink control information corresponding to multiple code rates, and the first code rate is determined based on at least one of the multiple code rates.

In a second aspect, an embodiment of the disclosure provides a terminal, which includes a memory and a processor.

The memory stores a computer program that, when executed by the processor, causes the processor to determine a power adjustment component of a first uplink control channel based on a first code rate. Here, the first uplink control channel is used for transmitting multiple uplink control information, the multiple uplink control information corresponding to multiple code rates, and the first code rate is determined based on at least one of the multiple code rates.

In a third aspect, an embodiment of the disclosure provides a non-transitory computer-readable storage medium having stored thereon one or more programs that, when executed by one or more processors, cause the one or more processors to determine a power adjustment component of a first uplink control channel based on a first code rate. Here, the first uplink control channel is used for transmitting multiple uplink control information, the multiple uplink control information corresponding to multiple code rates, and the first code rate is determined based on at least one of the multiple code rates.

In a fourth aspect, an embodiment of the disclosure provides a chip including a processor. The processor is configured to call and run a computer program from a memory, to enable a terminal equipped with the chip to perform the following operations including determining a power adjustment component of a first uplink control channel based on a first code rate. Here, the first uplink control channel is used for transmitting multiple uplink control information, the multiple uplink control information corresponding to multiple code rates, and the first code rate is determined based on at least one of the multiple code rates.

### BRIEF DESCRIPTION OF THE DRAWINGS

The drawings described herein are used for providing further understanding of the disclosure, and constitute a part of the disclosure. Exemplary embodiments of the disclosure and description thereof are used for illustrating the disclosure and not intended to form an improper limit to the disclosure. In the drawings:

FIG. 1 is a diagram illustrating an application scenario according to an embodiment of the disclosure.

FIG. 2 is a flowchart illustrating a method for determining a power adjustment component according to an embodiment of the disclosure.

FIG. 3 is a diagram illustrating multiplexing transmission of uplink control information with a high priority and uplink control information with a low priority according to the embodiment of the disclosure.

FIG. 4 is a structural diagram of a terminal according to an embodiment of the disclosure.

FIG. 5 is a structural diagram of a terminal according to an embodiment of the disclosure.

FIG. 6 is a structural diagram of a chip according to an embodiment of the disclosure.

### DETAILED DESCRIPTION

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

In embodiments of the disclosure, multiple/a plurality of refers to at least two, for example, two or more.

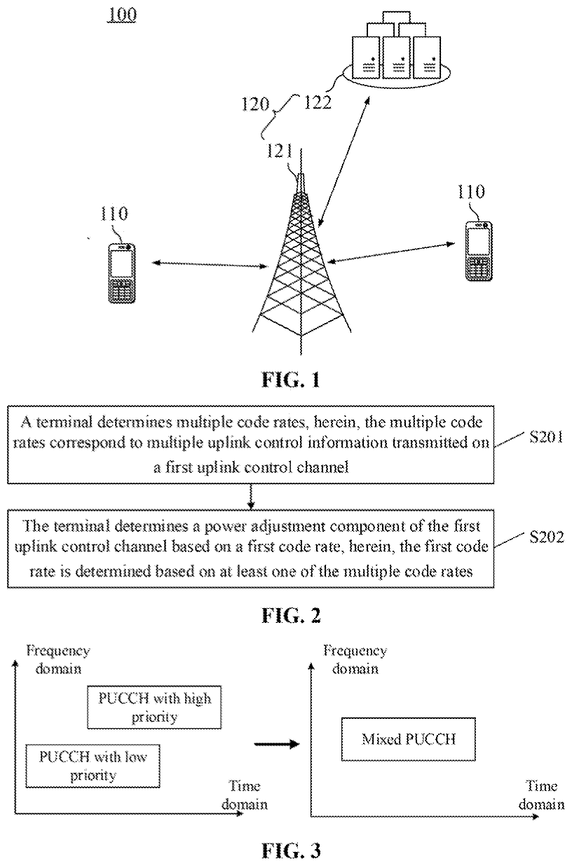

FIG. 1 is a diagram illustrating an application scenario according to an embodiment of the disclosure.

As illustrated in FIG. 1, a communication system 100 may include terminal devices (or terminals) 110 and a network device 120. The network device 120 may communicate with the terminal devices 110 through an air interface. Multi-service transmission is supported between the terminal devices 110 and the network device 120.

It should be understood that embodiments of the disclosure are described only with the communication system 100 as an example, but are is not limited thereto. That is, the technical solution of the embodiments of the disclosure may be applied to various communication systems, for example, a Long Term Evolution (LTE) system, an LTE Time Division Duplex (TDD) system, a Universal Mobile Telecommunications System (UMTS), an Internet of Things (IoT) system, a Narrow Band Internet of Things (NB-IoT) system, an enhanced Machine-Type Communications (eMTC) system, a 5th Generation (5G) communication system (also called a New Radio (NR) communication system), a future communication system (e.g., a 6th Generation (6G) communication system), and/or the like.

In the communication system 100 illustrated in FIG. 1, the network device 120 may be an access network device communicating with the terminal 110. The access network device may provide communication coverage for a specific geographical region and may communicate with terminals 110 (e.g., UE) located in the coverage.

The terminal 110 in the disclosure may be referred to as User Equipment (UE), a Mobile Station (MS), a Mobile Terminal (MT) or the like. The terminal may include one or a combination of at least two of the followings: a server, a mobile phone, a pad, a computer with a wireless transceiver function, a palmtop computer, a desktop computer, a personal digital assistant, a portable media player, a smart speaker, a navigation device, a wearable device such as a smart watch, smart glasses, a smart necklace or the like, a pedometer, a digital television (TV), a Virtual Reality (VR) terminal device, an Augmented Reality (AR) terminal device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, and a vehicle, a vehicle-mounted device, a vehicle-mounted module, a wireless modem, a handheld, Customer Premise Equipment (CPE) and a smart appliance in an Internet of vehicles system.

The network device 120 in the embodiments of the disclosure may include an access network device 121 and/or a core network device 122.

The access network device 121 may include one or a combination of at least two of the followings: an Evolutionary Node B (eNB or eNodeB) in an LTE system, a Next Generation Radio Access Network (NG RAN) device, a base station (gNB) in an NR system, a small station, a micro station, a wireless controller in a Cloud Radio Access Network (CRAN), a Wireless-Fidelity (Wi-Fi) access point, a transmission reception point (TRP), a relay station, an access point, a vehicle-mounted device, a wearable devices, a hub, a switch, a network bridge, a router, a network devices in the future evolution of a Public Land Mobile Network (PLMN), and/or the like.

The core network device 122 may be a 5G core (5GC) device, and the core network device 122 may include one or a combination of at least two of the followings: an Access and Mobility Management Function (AMF), an Authentication Server Function (AUSF), a User Plane Function (UPF), a Session Management Function (SMF), a Location Management Function (LMF). In other implementations, the core network device may also be an Evolved Packet Core (EPC) device in an LTE network, for example, a Session Management Function+Core Packet Gateway (SMF+PGW-C) device. It should be understood that SMF+PGW-C can achieve both SMF and PGW-C functions simultaneously. In the process of network evolution, the core network device 122 may also be called by other names, or at least one new network entity may be formed by dividing the functions of the core network, which is not limited by the embodiment of the disclosure.

At least one connection may be established between functional units of the communication system 100 through a next generation (NG) interface to realize communication.

For example, the terminal device establishes an air interface connection with the access network device through an NR interface, for transmitting user plane data and control plane signaling. The terminal device may establish a control plane signaling connection with the AMF through an NG interface 1 (abbreviated as N1). The access network device such as a next generation radio access base station (gNB) may establish a user plane data connection with the UPF through an NG interface 3 (abbreviated as N3). The access network device may establish a control plane signaling connection with the AMF through an NG interface 2 (abbreviated as N2). The UPF may establish a control plane signaling connection with the SMF through an NG interface 4 (abbreviated as N4). The UPF may interact user plane data with a data network through an NG interface 6 (abbreviated as N6). The AMF may establish a control plane signaling connection with the SMF through an NG interface 11 (abbreviated as N11). The SMF may establish a control plane signaling connection with a Packet Control Function (PCF) through an NG Interface 7 (abbreviated as N7).

FIG. 1 exemplarily illustrates one base station, one core network device, and two terminal devices. In some embodiments, the wireless communication system 100 may include multiple base stations and other number of terminal devices in the coverage of each base station, which is not limited by the embodiments of the disclosure.

It should be noted that FIG. 1 only illustrates the system to which the disclosure is applicable in a form of an example. Of course, the methods shown in the embodiments of the disclosure may also be applicable to other systems. In addition, the terms “system” and “network” used herein may usually be exchanged. Herein, the term “and/or” is merely an association relationship that describes associated objects, and represents that three relationships may exist. For example, A and/or B may represent three situations: independent existence of A, existence of both A and B and independent existence of B. In addition, the character “/” used herein usually represents that the associated objects before and after the character “/” form an “or” relationship. It should also be understood that “indication/indicate/indicating” mentioned in the embodiments of the disclosure may be a direct indication, an indirect indication, or representation of an association relationship. For example, A indicates B, which may represent that A directly indicates B, e.g., B may be obtained from A; or which may represent that A indirectly indicates B, e.g., A indicates C and B may be obtained from C; or which may represent that there is an association relationship between A and B. It should also be understood that the “correspondence/correspond/corresponding” mentioned in the embodiments of the disclosure may represent that there is a direct correspondence or an indirect correspondence between the two; or may represent an association relationship between the two, or a relationship between indication and being indicated, between configuration and being configured or the like. It should also be understood that “predefinition/predefine”, “predefinition by a protocol”, “pre-determination/pre-determine”, “pre-configuration/pre-configure” or “predefined rule” mentioned in the embodiments of the disclosure may be implemented by pre-storing corresponding codes, tables, or other ways that may be used to indicate related information in devices (e.g., including terminal devices and network devices), and the specific implementation thereof is not limited herein. For example, predefinition/predefine can refer to what is defined in the protocol. It should also be understood that in embodiments of the disclosure, the “protocol” may refer to standard protocols in the communication field, such as LTE protocol, NR protocol, and related protocols applied in future communication systems, which are not limited herein.

In order to reduce the decrease of transmission reliability caused by the loss of some uplink control information, when a collision/conflict occurs among different uplink control information, the embodiments of the disclosure adopt multiplexing transmission of the multiple different uplink control information using different transmission code rates, so that the transmission reliability of uplink control information and the overall transmission efficiency can be improved.

In the embodiments of the disclosure, any uplink control information (e.g., first uplink control information, second uplink control information, third uplink control information or the like as described below) may include at least one of: Hybrid Automatic Repeat reQuest (HARQ)-ACKnowledgement (ACK), a Scheduling Request (SR), or Channel State Information (CSI).

In some embodiments, the HARQ-ACK may include an ACK and a Negative ACKnowledgement (NACK), or may include one of an ACK and an NACK.

In the embodiments of the disclosure, any uplink control channel (e.g., a first uplink control channel, a second uplink control channel, a third uplink control channel, a fourth uplink control channel or the like as described below) may be a Physical Uplink Control Channel (PUCCH).

In the embodiments of the disclosure, a power of the uplink control channel may be determined by the following formula (1):

$${P}_{PUCCH} = min \{ \begin{matrix}{P}_{CMAX} \\ {P}_{O \_ PUCCH} + 10 {log}_{10} ( {2}^{μ} \cdot {M}_{RB}^{PUCCH} ) + PL ( {q}_{d} ) + {Δ}_{F \_ PUCCH} ( F ) + {Δ}_{TF} + g ( l )\end{matrix} [ dBm ] . \qquad ( 1 )$$

Herein, P_{PUCCH} is a power of a PUCCH; P_{CMAX} is a maximum output power of a terminal; P_{O_PUCCH} is a target received power (e.g., an anticipated received power on a network side, or an expected received power on the network side); M_{RB}^{PUCCH} is the number of Physical Resource Blocks (PRBs) of the PUCCH; PL(q_{d}) is a downlink path loss estimation; q_{d} is a downlink reference signal index; Δ_{F_PUCCH}(F) is an offset of a PUCCH format, where F is the PUCCH format; Δ_{TF} is an adjustment component of a PUCCH equivalent code rate, Δ_{TF} is also referred to as a power adjustment component of the PUCCH; and g(l) is an adjustment component of the PUCCH, where l is a power control adjustment index.

FIG. 2 is a flowchart of a method for determining a power adjustment component according to an embodiment of the disclosure. As illustrated in FIG. 2, the method includes the following operations S201 and S202.

At operation S201, a terminal determines multiple code rates. The multiple code rates correspond to multiple uplink control information transmitted on a first uplink control channel.

In some implementations, the multiple uplink control information may be transmitted on multiple uplink control channels, respectively. At least two of the multiple uplink control information may have the same priority or different priorities. For example, when the multiple uplink control information includes first uplink control information and second uplink control information, a priority of the first uplink control information may be same as a priority of the second uplink control information, or may be different from a priority of the second uplink control information.

The number of resources occupied by the first uplink control channel may be greater than, less than or equal to the number of resources occupied by the multiple uplink control channels.

In some implementations, the multiple uplink control information may include the first uplink control information corresponding to a first priority and the second uplink control information corresponding to a second priority.

The first priority may be higher than the second priority. In other implementations, the first priority may be lower than the second priority.

The first uplink control channel may transmit not only the first uplink control information but also the second uplink control information.

When there is no collision between the first uplink control information and the second uplink control information, the first uplink control information and the second uplink control information may be transmitted on a second uplink control channel and a third uplink control channel, respectively. For example, the second uplink control channel may be used to transmit the first uplink control information, and the third uplink control channel may be used to transmit the second uplink control information. That is, the first uplink control information may be carried on the second uplink control channel for transmission, and the second uplink control information may be carried on the third uplink control channel for transmission. The terminal may transmit the second uplink control channel and the third uplink control channel using different transmit powers or the same transmit power. An implementation in which there is no collision between the first uplink control information and the second uplink control information may be that: the second uplink control channel corresponding to the first uplink control information does not overlap with the third uplink control channel corresponding to the second uplink control information in a time domain.

When there is a collision between the first uplink control information and the second uplink control information, the first uplink control information and the second uplink control information may be multiplexed to the first uplink control channel for transmission, so that the first uplink control channel transmits not only the first uplink control information but also the second uplink control information. An implementation in which there is a collision between the first uplink control information and the second uplink control information may be that: the second uplink control channel corresponding to the first uplink control information overlaps with the third uplink control channel corresponding to the second uplink control information in the time domain.

A first code rate may be an equivalent code rate corresponding to the first uplink control channel. For example, the first code rate may be the equivalent code rate of the first uplink control information and the second uplink control information corresponding to the first uplink control channel.

The multiple code rates may include a second code rate and a third code rate.

The second code rate may be an equivalent code rate of the first uplink control information corresponding to the second uplink control channel.

The third code rate may be an equivalent code rate of the second uplink control information corresponding to the third uplink control channel.

The second code rate may be determined by a network configuration, or may be determined by information amount (e.g., the number of bits) of the first uplink control information and a resource corresponding to the first uplink control information in the first uplink control channel, or may be determined by information amount (e.g., the number of bits) of the first uplink control information and a resource corresponding to the second uplink control channel.

The third code rate may be determined by a network configuration, or may be determined by information amount (e.g., the number of bits) of the second uplink control information and a resource corresponding to the second uplink control information in the first uplink control channel, or may be determined by information amount (e.g., the number of bits) of the second uplink control information and a resource corresponding to the third uplink control channel.

The determination manner of the second code rate may be the same as or different from that of the third code rate.

At operation S202, the terminal determines the power adjustment component of the first uplink control channel based on the first code rate. The first code rate is determined based on at least one of the multiple code rates.

In some implementations, the terminal may determine a power at which the terminal transmits the first uplink control channel by the formula (1) above, after obtaining the power adjustment component of the first uplink control channel. In other implementations, the terminal may adjust a certain transmit power through the power adjustment component after obtaining the power adjustment component of the first uplink control channel, and transmit the first uplink control channel based on the adjusted transmit power.

In some implementations, the first code rate may be any one or more of the multiple code rates. In other implementations, the first code rate may be determined based on at least one of the multiple code rates. In an embodiment of the disclosure, the first code rate may include one code rate. In another embodiment, the first code rate may include multiple code rates.

In some implementations, the terminal may determine a highest code rate of the multiple code rates as the first code rate. In this way, the power adjustment component of the first uplink control channel that may be determined by the terminal based on the first code rate is high, and thus a determined transmit power of the first uplink control channel is high, which not only improves the transmission reliability of the uplink control information with a high priority, but also improves the transmission reliability of the uplink control information with a low priority.

In other implementations, the terminal may determine a lowest code rate of the multiple code rates as the first code rate. In this way, the power adjustment component of the first uplink control channel that may be determined by the terminal based on the first code rate is low, and thus a determined transmit power of the first uplink control channel is low, which may enable the terminal to transmit the first uplink control channel information at a lower power, thereby reducing the power consumption of the terminal and preferentially ensuring the transmission reliability of the uplink control information with a high priority.

Taking the multiple code rates including the second code rate and the third code rate as examples, the following will explain how the terminal determines the first code rate.

The terminal may determine the second code rate as the first code rate, or the terminal may determine the third code rate as the first code rate, or the terminal may determine a lower one of the second code rate and third code rate as the first code rate, or the terminal may determine a higher one of the second code rate and third code rate as the first code rate.

The terminal may determine to use one of the above manners based on predefinition by a protocol, or based on a pre-configuration, or based on a network configuration, or based on a configuration of other terminal(s), so as to determine the first code rate.

The terminal may determine whether to use the second code rate or the third code rate based on the information amount (e.g., the number of bits) of the first uplink control information and/or the information amount (e.g., the number of bits) of the second uplink control information.

For example, when the information amount of the first uplink control information is greater than the information amount of the second uplink control information, the terminal may adopt the second code rate corresponding to the first uplink control information. When the information amount of the first uplink control information is less than the information amount of the second uplink control information, the terminal may adopt the third code rate corresponding to the second uplink control information. In other cases, the first code rate is determined based on predefinition by the protocol, or based on the pre-configuration, or based on the network configuration, or based on the configuration of other terminal(s).

For another example, when a difference obtained by subtracting the information amount of the second uplink control information from the information amount of the first uplink control information is greater than a first value, the terminal uses the second code rate corresponding to the first uplink control information. When a difference obtained by subtracting the information amount of the first uplink control information from the information amount of the second uplink control information is greater than a second value, the terminal uses the third code rate corresponding to the second uplink control information. In other cases, the first code rate is determined based on predefinition by the protocol, or based on the pre-configuration, or based on the network configuration, or based on the configuration of other terminal(s). The first value may be greater than, less than, or equal to the second value.

The terminal may determine whether to use the second code rate or the third code rate based on a battery level state of the terminal and/or an operating mode of the terminal. For example, a higher one of the second code rate and the third code rate is determined as the first code rate when it is determined that a remaining battery level of the terminal is greater than a preset battery level, and/or when it is determined that the operating mode of the terminal is a normal operating mode. A lower one of the second code rate and the third code rate is determined as the first code rate when it is determined that the remaining battery level of the terminal is less than or equal to the preset battery level, and/or when it is determined that the operating mode of the terminal is a power saving operating mode.

The terminal may determine whether to use the second code rate or the third code rate based on the priority of the first uplink control information and/or the priority of the second uplink control information. For example, the terminal may adopt the second code rate corresponding to the first uplink control information when the priority of the first uplink control information is higher than a priority threshold and the priority of the second uplink control information is lower than or equal to the priority threshold.

In the embodiments of the disclosure, a terminal determines multiple code rates, which correspond to multiple uplink control information transmitted on a first uplink control channel, so that the multiple uplink control information can be transmitted on the first uplink control channel, which reduces the occurrence of situations in which some uplink control information cannot be transmitted, thereby improving the reliability of uplink control information transmission, and since different uplink control information can correspond to different code rates, thereby improving the transmission efficiency of the different uplink control information. Moreover, the terminal determines a first code rate based on at least one of the multiple code rates, so that a power adjustment component of the first uplink control channel can be determined based on the first code rate, which avoids the occurrence of situations in which the terminal cannot determine the power adjustment component corresponding to the first uplink control channel for transmitting the multiple uplink control information, and so that the terminal can determine the power for transmitting the first uplink control channel based on the power adjustment component of the first uplink control channel.

In some embodiments, the multiple uplink control information corresponds to multiple priorities.

For example, the multiple uplink control information may be in one-to-one correspondences with the multiple priorities. For another example, the multiple uplink control information may be in one-to-multiple correspondences or multiple-to-one correspondences with the multiple priorities. For example, the multiple uplink control information may include A, B, and C. The priority of A may be the same as the priority of B, and the priority of A may be different from the priority of C.

In some implementations, each of the multiple uplink control information has a respective priority. That is, different uplink control information has different priorities, in other words, any two of the priorities of the multiple uplink control information are different.

In some implementations, the terminal may multiplex the multiple uplink control information on the first uplink control channel for transmission. Each of the multiple uplink control information may be transmitted on a separate uplink control channel. For example, the terminal may multiplex the multiple uplink control information on the first uplink control channel for transmission when at least two of the multiple uplink control information collides with each other.

In some implementations, the method of determining the power adjustment component may further include that: the terminal may determine the multiple uplink control information respectively for transmission on the multiple uplink control channels, and multiplex the multiple uplink control information on the first uplink control channel for transmission.

In an implementation, the method for determining the power adjustment component may further include that: the terminal determines the multiple uplink control channels corresponding to the multiple uplink control information; and determines to multiplex the multiple uplink control information on the first uplink control channel for transmission when each of the multiple uplink control channels overlaps with at least one other uplink control channel of the multiple uplink control channels in a time domain.

The multiple uplink control information may be in one-to-one correspondences with the uplink control channels, in this way, one uplink control information corresponds to one uplink control channel which can be used for separate transmission of the one uplink control information, and the terminal may determine that the multiple uplink control information can be transmitted on the multiple uplink control channels, respectively.

Taking the multiple uplink control information including the first uplink control information and the second uplink control information as an example, the multiple uplink control channels may include the second uplink control channel and the third uplink control channel. The first uplink control information may be separately transmitted on the second uplink control channel and the second uplink control information may be separately transmitted on the third uplink control channel. In some implementations, the second uplink control channel overlaps or does not overlap with the third uplink control channel in the time domain.

When the terminal determines the second uplink control channel overlaps with the third uplink control channel in the time domain, the terminal determines that the first uplink control information collides with the second uplink control information, and the terminal may multiplex the first uplink control information and the second uplink control information on the first uplink control channel for transmission.

In some implementations, the first uplink control information or the second uplink control information may include uplink control information with one priority. In other implementations, the first uplink control information or the second uplink control information may include uplink control information with at least two priorities. One of a mean, a maximum value, a minimum value, a mode, a median and the like of the at least two priorities may be determined as a priority of the first uplink control information or a priority of the second uplink control information. For example, the first uplink control information or the second uplink control information may be obtained by multiplexing multiple sub-uplink control information. For example, a first sub-uplink control information and a second sub-uplink control information are multiplexed to obtain the first uplink control information, and/or a third sub-uplink control information and a fourth sub-uplink control information are multiplexed to obtain the second uplink control information. For the first sub-uplink control information to the fourth sub-uplink control information, different sub-uplink control information may have different priorities.

Taking the multiple uplink control information including the first uplink control information, the second uplink control information and third uplink control information as an example, the multiple uplink control channels may include the second uplink control channel, the third uplink control channel and a fourth uplink control channel. The first uplink control information may be transmitted on the second uplink control channel, the second uplink control information may be transmitted on the third uplink control channel, and the third uplink control information may be transmitted on the fourth uplink control channel. Each of the second uplink control channel, the third uplink control channel and the fourth uplink control channel may overlap with at least one other uplink control channel of the second uplink control channel, the third uplink control channel and the fourth uplink control channel in the time domain.

For example, when the terminal at least determines that the second uplink control channel overlaps with the third uplink control channel in the time domain, and that the second uplink control channel overlaps with the fourth uplink control channel in the time domain, the terminal may determine that there is a collision among the first uplink control information, the second uplink control information and the third uplink control information, and may multiplex the first uplink control information, the second uplink control information and the third uplink control information on the first uplink control channel for transmission.

It should be noted that the embodiments of the disclosure only list scenarios in which the multiple uplink control information includes two or three pieces of uplink control information. However, in other implementations, the multiple uplink control information may include another number of pieces of uplink control information, for example, four or five pieces or the like, which is not limited by the embodiments of the disclosure.

In some embodiments, the first uplink control channel is different from each of the multiple uplink control channels. In other embodiments, the first uplink control channel is one of the multiple uplink control channels.

In some implementations, the first uplink control channel and a target uplink control channel of the multiple uplink control channels may be identical in at least one of: a time domain position, a time domain start position, or a time domain end position. The target uplink control channel may be the first one of the multiple uplink control channels in order of time domain, or may be the last one of the multiple uplink control channels in order of time domain, or may be the middle one of the multiple uplink control channels in order of time domain.

In some implementations, the time domain position of the first uplink control channel may be ahead of time domain positions of the multiple uplink control channels, or may be behind of time domain positions of the multiple uplink control channels, or may be in time domain positions of the multiple uplink control channels.

The first uplink control channel and uplink control channel with a maximum time domain length of the multiple uplink control channel may be identical in the time domain length; or the first uplink control channel and uplink control channel with a minimum time domain length of the multiple uplink control channel may be identical in the time domain length; or a time domain length of the first uplink control channel may be greater than or less than the maximum time domain length; or a time domain length of the first uplink control channel may be less than or greater than the minimum time domain length. The first uplink control channel and uplink control channel with a maximum frequency domain length of the multiple uplink control channel may be identical in the frequency domain length; or the first uplink control channel and uplink control channel with a minimum frequency domain length of the multiple uplink control channel may be identical in the frequency domain length; or a frequency domain length of the first uplink control channel may be greater than or less than the maximum frequency domain length; or a frequency domain length of the first uplink control channel may be less than or greater than the minimum frequency domain length.

In some embodiments, the first code rate includes at least one of: any one of the multiple code rates; a lowest code rate of the multiple code rates; a highest code rate of the multiple code rates; a mean of the multiple code rates; a mode of the multiple code rates; a median of the multiple code rates; a code rate of the multiple code rates corresponding to uplink control information with a high priority; or a code rate of the multiple code rates corresponding to uplink control information with a low priority.

Taking the multiple code rates including 0.1, 0.2, 0.2, 0.3 and 0.7 as an example. The first code rate is 0.1 when the first code rate is the lowest code rate of the multiple code rates. The first code rate is 0.7 when the first code rate is the highest code rate of the multiple code rates. The first code rate is 0.3 when the first code rate is the mean of the multiple code rates. The first code rate is 0.2 when the first code rate is the mode of the multiple code rates, where the mode generally refers to one or more data occurring most frequently in a set of data. The first code rate is 0.2 when the first code rate is the median of the multiple code rates, where the median generally refers to the data in the middle position in a set of data arranged in sequence, and an average of two middle data can usually be taken as the median when the total number of the set of data is even.

In some implementations, the uplink control information with the high priority may be uplink control information with a highest priority of the multiple uplink control information corresponding to the multiple code rates, or may be any uplink control information with a priority higher than a first threshold of the multiple uplink control information corresponding to the multiple code rates. The uplink control information with the low priority may be uplink control information with a lowest priority of the multiple uplink control information corresponding to the multiple code rates, or may be any uplink control information with a priority lower than a second threshold of the multiple uplink control information corresponding to the multiple code rates.

When the first code rate is any one of the multiple code rates, the terminal may randomly select a code rate from the multiple code rates as the first code rate, or the terminal may takes a first obtained code rate of the multiple code rates as the first code rate.

When the multiple code rates include the second code rate and the third code rate, the terminal may determine the second code rate as the first code rate, or may determine the third code rate as the first code rate, or may determine a lower one of the second and third code rates as the first code rate, or may determine a higher one of the second and third code rates as the first code rate, or may determine a mean of the second and third code rates as the first code rate.

In some embodiments, the first code rate may be determined based on at least one of: predefinition by a protocol, a network configuration, or a pre-configuration.

Take the multiple code rates including the second code rate and the third code rate as an example.

When the first code rate is the lower one of the second code rate and the third code rate or the higher one of the second code rate and the third code rate based on the predefinition by the protocol, the terminal may determine the lower one as the first code rate or may determine the higher one as the second code rate.

When the terminal receives, from a network device, configuration information indicating that the first code rate is the lower one of the second code rate and the third code rate or the first code rate is the higher one of the second code rate and the third code rate, the terminal may determine the lower one as the first code rate or may determine the higher one as the second code rate.

The terminal may pre-configure the first code rate as the lower one of the second code rate and the third code rate, or the first code rate as the higher one of the second code rate and the third code rate.

In some embodiments, the multiple code rates include the second code rate and a third code rate. The second code rate corresponds to the first uplink control information transmitted on the first uplink control channel, and the third code rate corresponds to the second uplink control information transmitted on the first uplink control channel.

In some implementations, the priority of the first uplink control information is the first priority, and the priority of the second uplink control information is the second priority.

In some implementations, the first uplink control information may be all or part of all uplink control information corresponding to the second uplink control channel, and the second uplink control information may be all or part of all uplink control information corresponding to the third uplink control channel.

A transmit power of the first uplink control channel determined based on the first code rate should not be greater than a transmit power threshold of the first uplink control channel.

In some embodiments, the terminal may determine the first code rate based on the second code rate, the third code rate and the transmit power threshold corresponding to the first uplink control channel.

In some embodiments, the terminal determines the first code rate based on the second code rate, the third code rate and the transmit power threshold corresponding to the first uplink control channel, which includes that: the terminal determines a first transmit power corresponding to the higher one of the second code rate and the third code rate; and determines that the first code rate is the lower one of the second code rate and the third code rate, when the first transmit power is greater than the transmit power threshold.

When the terminal determines that the first code rate is the higher one of the second code rate and the third code rate based on predefinition by the protocol, the network configuration and/or the pre-configuration, the terminal may determine the first transmit power corresponding to the higher code rate. When the first transmit power corresponding to the higher code rate is greater than the transmit power threshold, the terminal determines that the first code rate is the lower one of the second code rate and the third code rate.

In some implementations, when the first transmit power is greater than the transmit power threshold, if the terminal determines that a second transmit power corresponding to the lower code rate is greater than the transmit power threshold, the terminal determines that the transmit power of the first uplink control channel is the transmit power threshold; if the terminal determines that the second transmit power is less than or equal to the transmit power threshold, the terminal determines that the first code rate is the lower code rate.

In the embodiments of the disclosure, the transmit power may be referred to as the transmitting power/transmission power, and the transmit power threshold may be referred to as the transmitting power threshold/transmission power threshold.

An implementation in which the terminal determines the transmit power corresponding to the higher code rate or the lower code rate may be that: the terminal determines a power adjustment component corresponding to the higher code rate or the lower code rate, and determines a transmit power corresponding to the higher code rate or the lower code rate based on the power adjustment component corresponding to the higher code rate or the lower code rate.

In some embodiments, the second code rate may be determined based on a network configuration. For example, the network device may transmit first information to the terminal. The first information may indicate the second code rate; or the first information may indicate that a code rate of the first uplink control information on the first uplink control channel is the second code rate; or the first information may indicate that a code rate corresponding to the second uplink control channel is the second code rate; or a code rate corresponding to a time domain or a time-frequency domain including the second uplink control channel is the second code rate; so that the terminal device determines that the code rate corresponding to the first uplink control information is the second code rate based on the received first information.

In other embodiments, the second code rate may be determined based on a pre-configuration. In this way, the terminal can pre-configure the second code rate, or the terminal can pre-configure a code rate of the first uplink control information on the first uplink control channel as the second code rate; or the terminal can pre-configure a code rate corresponding to the second uplink control channel as the second code rate; or the terminal can pre-configure a code rate corresponding to a time domain or a time-frequency domain including the second uplink control channel as the second code rate.

In yet other embodiments, the second code rate is determined based on the number of bits of the first uplink control information and a resource for transmitting the first uplink control information in the first uplink control channel.

In still other embodiments, the second code rate is determined based on the number of bits of the first uplink control information and a resource corresponding to the second uplink control channel.

In still other embodiments, the second code rate is determined based on a code rate corresponding to the second uplink control channel for separately carrying the first uplink control information.

In still other embodiments, the second code rate is determined based on a code rate corresponding to the first uplink control information when transmitted on the first uplink control channel.

The code rate corresponding to the second uplink control channel may be determined based on a network configuration or a pre-configuration, or may be determined based on the number of bits of the first uplink control information and the resource corresponding to the second uplink control channel.

The code rate corresponding to the first uplink control information on the first uplink control channel may be determined based on a network configuration or a pre-configuration, or may be determined based on the number of bits of the first uplink control information and the resource for transmitting the first uplink control information in the first uplink control channel.

In some embodiments, the third code rate may be determined based on a network configuration. For example, the network device may transmit second information to the terminal. The second information may indicate the third code rate; or the second information may indicate that a code rate of the second uplink control information on the first uplink control channel is the third code rate; or the second information may indicate that a code rate corresponding to the third uplink control channel is the third code rate; or a code rate corresponding to a time domain or a time-frequency domain including the third uplink control channel is the third code rate; so that the terminal device determines that the code rate corresponding to the second uplink control information is the third code rate based on the received second information.

In other embodiments, the third code rate may be determined based on a pre-configuration. In this way, the terminal can pre-configure the third code rate, or the terminal can pre-configure a code rate of the second uplink control information on the first uplink control channel as the third code rate; or the terminal can pre-configure a code rate corresponding to the third uplink control channel as the third code rate; or the terminal can pre-configure a code rate corresponding to a time domain or a time-frequency domain including the third uplink control channel as the third code rate.

In yet other embodiments, the third code rate is determined based on the number of bits of the second uplink control information and a resource for transmitting the second uplink control information in the first uplink control channel.

In still other embodiments, the third code rate is determined based on the number of bits of the second uplink control information and a resource corresponding to the third uplink control channel.

In still other embodiments, the third code rate is determined based on a code rate corresponding to the third uplink control channel for separately carrying the second uplink control information.

In still other embodiments, the third code rate is determined based on a code rate corresponding to the second uplink control information when transmitted on the first uplink control channel.

The code rate corresponding to the third uplink control channel may be determined based on a network configuration or a pre-configuration, or may be determined based on the number of bits of the second uplink control information and the resource corresponding to the third uplink control channel.

The code rate corresponding to the second uplink control information on the first uplink control channel may be determined based on a network configuration or a pre-configuration, or may be determined based on the number of bits of the second uplink control information and the resource for transmitting the second uplink control information in the first uplink control channel.

An implementation in which the terminal determines the second code rate and/or the third code rate based on the pre-configuration may be that: the terminal can store correspondences between the priorities of the uplink control information and the code rates of the uplink control information; determine the code rate corresponding to the first uplink control information as the second code rate based on the correspondences; and determine the code rate corresponding to the second uplink control information as the third code rate based on the correspondences. In other implementations, the terminal does not store the correspondences but receives the correspondences sent by the network device.

In some implementations, the second code rate may be determined in the same manner as the third code rate. For example, both the second code rate and the third code rate may be determined based on the network configuration or the pre-configuration. For another example, both the second code rate and the third code rate may be determined based on the number of bits of the corresponding uplink control information and the resource for transmitting the corresponding uplink control information in the first uplink control channel.

In other implementations, the second code rate may be determined in a different manner from the third code rate. For example, the second code rate is determined based on the network configuration or the pre-configuration, and the third code rate is determined based on the number of bits of the second uplink control information and the resource for transmitting the second uplink control information in the first uplink control channel. Or, the third code rate is determined based on the network configuration or the pre-configuration, and the second code rate is determined based on the number of bits of the first uplink control information and the resource for transmitting the first uplink control information in the first uplink control channel.

The method for determining the second code rate is described below.

In some embodiments, when the number of bits of the first uplink control information is less than or equal to a first threshold, the second code rate is determined based on the number of bits of at least one of first feedback information (e.g., HARQ-ACK), a first scheduling request or first channel state information in the first uplink control information, and based on the first number of resource elements for transmitting the first uplink control information in the first uplink control channel. In some implementations, the scheduling request may be scheduling request information.

In the embodiments of the disclosure, the first threshold may be 11. In other embodiments, the first threshold may be other numerical values, which are not limited by the embodiments of the disclosure.

For example, when the number of bits of the first uplink control information is less than or equal to the first threshold, the second code rate A2 is determined by the following formula (2):

A2=(O_{HARQ-ACK}+O_{SR}+O_{CSI})/N_{RE} (2).

In other embodiments, when the number of bits of the first uplink control information is greater than the first threshold, the second code rate is determined based on the number of bits of at least one of the first feedback information, the first scheduling request, the first channel state information or a first cyclic redundancy check (CRC) in the first uplink control information, and based on the first number of resource elements for transmitting the first uplink control information in the first uplink control channel. In some implementations, the cyclic redundancy check can be a cyclic redundancy check code.

For example, when the number of bits of the first uplink control information is greater than the first threshold, the second code rate A2 is determined by the following formula (3):

A2=(O_{HARQ-ACK}+O_{SR}+O_{CSI}+O_{CRC})/N_{RE} (3).

In formula (2) and formula (3): O_{HARQ-ACK} is the number of bits of the first feedback information; O_{SR} is the number of bits of the first scheduling request (i.e., a number of the first SR information bits); O_{CSI} is the number of bits of the first channel state information (i.e., a number of the first CSI information bits); N_{RE} is the first number, in other embodiments, N_{RE} is the number of resource elements corresponding to the second uplink channel; and O_{CRC} the number of bits of the first cyclic redundancy check (i.e., a number of the first CRC bits).

In some implementations, In formula (2) and formula (3): N_{RE} may be determined by M_{RB}^{PUCCH}*N^{RB}*N^{PUCCH}. Herein, M_{RB}^{PUCCH} represents the number of PRBs of the second uplink control channel; N^{RB} represents the number of subcarriers per resource block excluding subcarriers used for Demodulation Reference Signal (DM-RS) transmission; N^{PUCCH} represents the number of symbols of the second uplink control channel excluding symbols used for DM-RS transmission.

In other embodiments, when the number of bits of the first uplink control information is less than the first threshold, the second code rate A2 is determined by formula (2). When the number of bits of the first uplink control information is greater than or equal to the first threshold, the second code rate A2 is determined by formula (3).

In yet other embodiments, when the number of bits of the first uplink control information is less than the first threshold, the second code rate A2 is determined by formula (2). When the number of bits of the first uplink control information is greater than the first threshold, the second code rate A2 is determined by formula (3). When the number of bits of the first uplink control information is equal to the first threshold, the second code rate A2 is determined by formula (2) or formula (3).

The method for determining the third code rate is described below.

In some embodiments, when the number of bits of the second uplink control information is less than or equal to the first threshold, the third code rate is determined based on the number of bits of at least one of second feedback information, a second scheduling request or second channel state information in the second uplink control information, and based on the second number of resource elements for transmitting the second uplink control information in the first uplink control channel.

For example, when the number of bits of the second uplink control information is less than or equal to the first threshold, the third code rate A3 is determined by the following formula (4):

A3=(O_{HARQ-ACK}+O_{SR}+O_{CSI})/N_{RE} (4).

In other embodiments, when the number of bits of the second uplink control information is greater than the first threshold, the third code rate is determined based on the number of bits of at least one of the second feedback information, the second scheduling request, the second channel state information or a second cyclic redundancy check in the second uplink control information, and based on the second number of resource elements for transmitting the second uplink control information in the first uplink control channel.

For example, when the number of bits of the second uplink control information is greater than the first threshold, the third code rate A3 is determined by the following formula (5):

A3=(O_{HARQ-ACK}+O_{SR}+O_{CSI}+O_{CRC})/N_{RE} (5).

In formula (4) and formula (5): O_{HARQ-ACK} is the number of bits of the second feedback information; O_{SR} is the number of bits of the second scheduling request (i.e., a number of the second SR information bits); O_{CSI} is the number of bits of the second channel state information (i.e., a number of the second CSI information bits); N_{RE} is the second number, in other embodiments, N_{RE} is the number of resource elements corresponding to the third uplink control channel; and O_{CRC} the number of bits of the second cyclic redundancy check (i.e., a number of the second CRC bits).

In some embodiments, the number of bits of feedback information (including the first feedback information or the second feedback information) may be: a number of HARQ-ACK information bits determined for the HARQ-ACK codebook. If the UE is not provided any of pdsch-HARQ-ACK-Codebook, pdsch-HARQ-ACK-Codebook-r16, or pdsch-HARQ-ACK-OneShotFeedback, O_{HARQ-ACK}=1 if the UE includes a HARQ-ACK information bit in the PUCCH transmission. Otherwise, O_{HARQ-ACK}=0. In some implementations, O_{HARQ-ACK} may also be referred to as n_{HARQ-ACK}(i). In the embodiments of the disclosure, i refers to a transmission occasion index.

In some embodiments, In formula (4) and formula (5): N_{RE} may be determined by M_{RB}^{PUCCH}*N^{RB}*N_{PUCCH}. Herein, M_{RB}^{PUCCH} represents the number of PRBs of the third uplink control channel; N^{RB} represents the number of subcarriers per resource block excluding subcarriers used for Demodulation Reference Signal (DM-RS) transmission; N^{PUCCH} represents the number of symbols of the third uplink control channel excluding symbols used for DM-RS transmission.

In other embodiments, when the number of bits of the second uplink control information is less than the first threshold, the third code rate A3 is determined by formula (4). When the number of bits of the second uplink control information is greater than or equal to the first threshold, the third code rate A3 is determined by formula (5).

In yet other embodiments, when the number of bits of the second uplink control information is less than the first threshold, the third code rate A3 is determined by formula (4). When the number of bits of the second uplink control information is greater than the first threshold, the third code rate A3 is determined by formula (5). When the number of bits of the second uplink control information is equal to the first threshold, the third code rate A3 is determined by formula (4) or formula (5).

The method for determining the power adjustment component based on the first code rate is described below.

In some embodiments, the operation S202 that the terminal determines the power adjustment component of the first uplink control channel based on the first code rate may include an operation as follows. The terminal determines the power adjustment component based on the first code rate when a format of the first uplink control channel is format 2, format 3 or format 4.

In some embodiments, the operation that the terminal determines the power adjustment component based on the first code rate when the format of the first uplink control channel is format 2, format 3 or format 4 may include: when the format of the first uplink control channel is format 2, format 3 or format 4, and the number of bits of the uplink control information on the first uplink control channel is less than or equal to the first threshold, the terminal determines the power adjustment component based on 10*log₁₀(K₁*A) Herein, K₁ is a first constant; A is the first code rate; and log represents a logarithmic function. In some embodiments, K₁=6.

In some embodiments, the operation that the terminal determines the power adjustment component based on the first code rate when the format of the first uplink control channel is format 2, format 3 or format 4 may include: when the format of the first uplink control channel is format 2, format 3 or format 4, and the number of bits of the uplink control information on the first uplink control channel is greater than the first threshold, the terminal determines the power adjustment component based on 10*log₁₀(2^{K}^{₂}^{*A}−1). Herein, K₂ is a second constant; A is the first code rate; and log represents a logarithmic function. In some embodiments, K₂=2.4.

The power adjustment component may also be determined based on the number of symbols of the first uplink control channel and the number of bits of uplink control information on the first uplink control channel. For example, the method in the embodiments of the disclosure may further include an operation as follows. When the format of the first uplink control channel is format 0 or format 1, the terminal determines the power adjustment component based on the number of symbols of the first uplink control channel and the number of bits of the uplink control information on the first uplink control channel.

In some embodiments, the operation that the terminal determines the power adjustment component based on the number of symbols of the first uplink control channel and the number of bits of the uplink control information on the first uplink control channel includes the following operation.

The terminal determines the power adjustment component based on

$$10 * {log}_{10} ( \frac{N}{M} + {Δ}_{UCI} ) .$$

Herein, M is the number of symbols of the first uplink control channel; or in the first uplink control channel, a number of PUCCH format 0 symbols or PUCCH format 1 symbols for the PUCCH transmission.

Herein, N is 2 when the format of the first uplink control channel is format 0 (i.e., N=2 for PUCCH format 0); N is a number of symbols in a slot when the format of the slot first uplink control channel is format 1 (i.e., N=N_{symb}^{slot} for PUCCH format 1). In some implementations, the number of symbols in the slot can be the number of symbols in one slot.

Herein, Δ_{UCI} is 0 when the format of the first uplink control channel is format 0 (i.e., Δ_{UCI}=0 for PUCCH format 0); Δ_{UCI} is 10*log₁₀(O_{uci}) when the format of the first uplink control channel is format 1 (i.e., Δ_{UCI}=10*log₁₀(O_{uci}) for PUCCH format 1). O_{uci} is the number of bits of the uplink control information on the first uplink control channel (i.e., a number of UCI bits in PUCCH transmission occasion i).

Herein, log represents a logarithmic function.

Taking the first uplink control information being uplink control information with a high priority and the second uplink control information being uplink control information with a low priority as an example, the method for determining the power adjustment component provided by the embodiments of the disclosure is described below.

The terminal may determine the second uplink control channel for transmitting the uplink control information with the high priority and the third uplink control channel for transmitting the uplink control information with the low priority. The second uplink control channel overlaps with the third uplink control channel in time domain.

The terminal multiplexes the uplink control information with the high priority and the uplink control information with the low priority for transmission on the first uplink control channel, and an equivalent code rate of the uplink control information with the high priority and an equivalent code rate of the uplink control information with the low priority are independently configured.

The terminal determines the power adjustment component of the first uplink control channel based on the first code rate. The first code rate is determined based on the equivalent code rate of the uplink control information with the high priority and/or the equivalent code rate of the uplink control information with the low priority.

The first code rate can be at least one of: the equivalent code rate of the uplink control information with the high priority (corresponding to the second code rate mentioned above); the equivalent code rate of the uplink control information with the low priority (corresponding to the third code rate mentioned above); the lower one of the equivalent code rate of the uplink control information with the high priority and the equivalent code rate of the uplink control information with the low priority; or the higher one of the equivalent code rate of the uplink control information with the high priority and the equivalent code rate of the uplink control information with the low priority.

The first code rate is determined based on predefinition by a protocol, or is configured by a network, or is switched according to a judgment condition. The judgment condition can refer to whether the transmit power of the terminal reaches a transmit power upper limit. For example, the power adjustment component may be determined according to the equivalent code rate of the uplink control information with the low priority, or the higher one of the equivalent code rate of the uplink control information with the high priority and the equivalent code rate of the uplink control information with the low priority. If the transmit power determined by the terminal based on the power adjustment component exceeds the transmit power upper limit (corresponding to the transmit power threshold mentioned above), the power adjustment component is determined according to the equivalent code rate of the uplink control information with the high priority, or the lower one of the equivalent code rate of the uplink control information with the high priority and the equivalent code rate of the uplink control information with the low priority. Otherwise, the original power adjustment component is maintained.

The second code rate or the third code rate can be determined based on information amount (e.g. the number of bits of the uplink control information with the high priority or the number of bits of uplink control information with the low priority) and a corresponding resource.

When the number of bits of the uplink control information with the high priority or the uplink control information with the low priority is less than or equal to 11, the first code rate A1 may be determined by the following manner. A1=(O_{HARQ-ACK}+O_{SR}+O_{CSI})/N_{RE}.

When the number of bits of the uplink control information with the high priority or the uplink control information with the low priority is greater than 11, the first code rate A1 is determined by the following manner. A1=(O_{HARQ-ACK}+O_{SR}+O_{CSI}+O_{CRC})/N_{RE}.

The second code rate or third code rate can be determined by direct or indirect network configuration. The determination by the direct network configuration includes, but is not limited to, 1) the code rate of the uplink control information with the high priority is determined according to the code rate corresponding to the uplink control channel for specially carrying high priority information, and the code rate of the uplink control information with the low priority is determined according to the code rate corresponding to the uplink control channel for specially carrying low priority information; or 2) the code rate of the uplink control information with the high priority is determined according to a high priority information-specific code rate corresponding to the uplink control channel for multiplexing the high priority information and the low priority information, and the code rate of the uplink control information with the low priority is determined according to a low priority information-specific code rate corresponding to the uplink control channel for multiplexing the high priority information and the low priority information.

Different code rates determination methods may be adopted for the uplink control information with the high priority and the uplink control information with the low priority. For example, the code rate corresponding to the uplink control information with the high priority is determined by the network configuration; and the code rate corresponding to the uplink control information with the low priority is determined by information amount and a corresponding resource.

The terminal determines the power adjustment component of the first uplink control channel based on the first code rate as follows.

For a format of the uplink control channel being format 0 or format 1, the power adjustment component of the first uplink control channel is

$${Δ}_{TF} = 10 {log}_{10} ( \frac{N}{M} + {Δ}_{UCI} ) .$$

For the format of the first uplink control channel being format 2, format 3 or format 4, and the number of bits of the uplink control information being less than or equal to 11, the power adjustment component of the first uplink control channel is Δ_{TF}=10*log₁₀(K₁*A).

For the format of the first uplink control channel being format 2, format 3 or format 4, and the number of bits of the uplink control information being greater than 11, the power adjustment component of the first uplink control channel is Δ_{TF}=10*log₁₀(2^{K}^{₂}^{*A}−1).

FIG. 3 is a diagram illustrating multiplexing transmission of uplink control information with a high priority and uplink control information with a low priority according to an embodiment of the disclosure. As illustrated in FIG. 3, PUCCH with the high priority overlaps with PUCCH with the low priority in time domain, and the uplink control information with the high priority and the uplink control information with the low priority are multiplexed to a first PUCCH for transmission. Respective code rates are independently determined for the uplink control information with the high priority and the uplink control information with the low priority which are transmitted on the first PUCCH. The first PUCCH may be referred to as a mixed PUCCH.

For example, if a high priority uplink control information code rate A2 is configured for the PUCCH format of the first PUCCH, the code rate of the uplink control information with the high priority is A2, and the code rate A3 of the uplink control information with the low priority is determined according to the information amount of the uplink control information with the low priority and at least one corresponding resource element (RE).

In the embodiments of the disclosure, a code rate or a maximum code rate corresponding to the low priority control information is adopted to ensure the reliability of all uplink control information; or a code rate or a minimum code rate corresponding to the high priority control information is adopted to preferentially ensure the reliability of the high priority control information in priority, thereby improving the transmission efficiency.

The preferred embodiments of the disclosure have been described in detail with reference to the drawings, but the disclosure is not limited to the specific details of the above embodiments. Various simple modifications can be made to the technical solutions of the disclosure within the scope of the technical conception of the disclosure, all of which fall within the scope of protection of the disclosure. For example, the specific technical features described in the above specific embodiments/implementations may be combined in any suitable manner without conflict with each other, and various possible combinations are not further described in the disclosure in order to avoid unnecessary repetition. For another example, different embodiments/implementations of the disclosure can be combined arbitrarily, and the combined embodiments/implementations should also be regarded as the contents disclosed in the disclosure as long as they do not violate the idea of the disclosure. For another example, the embodiments/implementations and/or features of the embodiments/implementations described in the disclosure may be arbitrarily combined with the related arts without conflict, and the solutions obtained through any combination should fall within the scope of protection of the disclosure.

It should be understood that the magnitude of serial numbers of the foregoing processes/operations do not mean execution sequences in various method embodiments of the disclosure. The execution sequences of the processes should be determined according to functions and internal logics of the processes, and should not be construed as any limitation to implementation processes of the embodiments of disclosure. In addition, in the embodiments of the disclosure, the terms “downlink”, “uplink” and “sidelink” are used to denote a transmission direction of the signal or data. The term “downlink” is used to denote that the transmission direction of the signal or data is a first direction from a station to UE of the cell, the term “uplink” is used to denote that the transmission direction of the signal or data is a second direction from UE of the cell to the station, and the term “sidelink” is used to denote that the transmission direction of the signal or data is a third direction from first user equipment (UE1) to second user equipment (UE2). For example, “downlink signal” means that the transmission direction of the signal is the first direction. In addition, in the embodiments of the disclosure, the term “and/or” is only an association relationship describing associated objects and represents that there are three relationships. Specifically, A and/or B may represent three situations: independent existence of A, existence of both A and B and independent existence of B. In addition, character “/” used herein usually represents that the associated objects before and after form an “or” relationship.

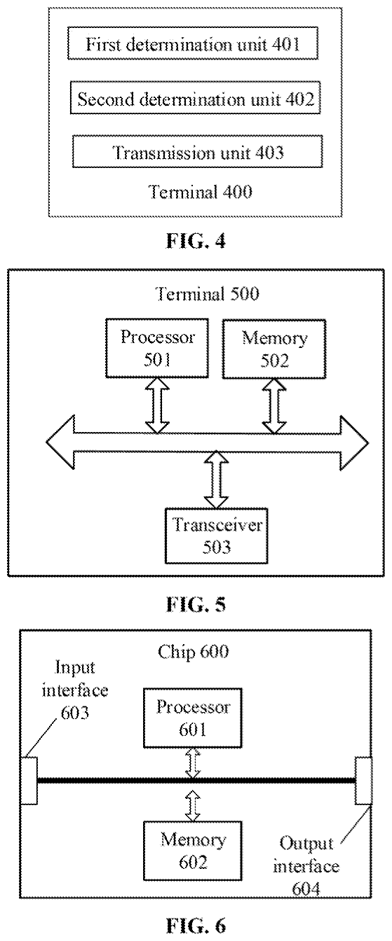

FIG. 4 is a structural diagram of a terminal according to an embodiment of the disclosure. The terminal may be a chip or a processor, and the terminal 400 may be applied to the above-mentioned terminal. The terminal 400 includes a first determination unit 401 and a second determination unit 402. The first determination unit 401 is configured to determine multiple code rates. The Multiple code rates correspond to multiple uplink control information transmitted on a first uplink control channel. A second determination unit is configured to determine a power adjustment component of the first uplink control channel based on a first code rate. The first code rate is determined based on at least one of the multiple code rates.

In some embodiments, the multiple uplink control information correspond to multiple priorities.

In some embodiments, the terminal 400 further includes a transmission unit 403. The transmission unit 403 is configured to determine multiple uplink control channels corresponding to the multiple uplink control information; and determine to multiplex the multiple uplink control information on the first uplink control channel for transmission, when each of the multiple uplink control channels overlaps with at least one other uplink control channel of the multiple uplink control channels in a time domain.

In some embodiments, the first code rate includes at least one of: any one of the multiple code rates; a lowest code rate of the multiple code rates; a highest code rate of the multiple code rates; a mean of the multiple code rates; a mode of the multiple code rates; a median of the multiple code rates; a code rate corresponding to uplink control information with a high priority among the multiple code rates; or a code rate corresponding to uplink control information with a low priority among the multiple code rates.

In some embodiments, the first code rate is determined based on at least one of: predefinition by a protocol, a network configuration, or a pre-configuration.

In some embodiments, the multiple code rates include a second code rate and a third code rate. The second code rate corresponds to a first uplink control information transmitted on the first uplink control channel, and the third code rate corresponds to a second uplink control information transmitted on the first uplink control channel.

In some embodiments, a priority of the first uplink control information is a first priority, and a priority of the second uplink control information is a second priority.

In some embodiments, the second determination unit 402 is further configured to determine the first code rate based on the second code rate, the third code rate and a transmit power threshold corresponding to the first uplink control channel.

In some embodiments, the second determination unit 402 is further configured to determine a first transmit power corresponding to a higher one of the second code rate and the third code rate; and determines that the first code rate is a lower one of the second code rate and the third code rate, when the first transmit power is greater than the transmit power threshold.

In some embodiments, the second code rate may be determined based on a network configuration; or the second code rate is determined based on a pre-configuration; or the second code rate is determined based on the number of bits of the first uplink control information and a resource for transmitting the first uplink control information in the first uplink control channel; or the second code rate is determined based on a code rate corresponding to a second uplink control channel for separately carrying the first uplink control information; or the second code rate is determined based on a code rate corresponding to the first uplink control information when transmitted on the first uplink control channel.

In some embodiments, the third code rate is determined based on a network configuration; or the third code rate is determined based on a pre-configuration; or the third code rate is determined based on the number of bits of the second uplink control information and a resource for transmitting the second uplink control information in the first uplink control channel; or the third code rate is determined based on a code rate corresponding to a third uplink control channel for separately carrying the second uplink control information; or the third code rate is determined based on a code rate corresponding to the second uplink control information when transmitted on the first uplink control channel.

In some embodiments, when the number of bits of the first uplink control information is less than or equal to a first threshold, the second code rate is determined based on the number of bits of at least one of first feedback information, a first scheduling request or first channel state information in the first uplink control information, and based on the first number of resource elements for transmitting the first uplink control information in the first uplink control channel.

When the number of bits of the first uplink control information is greater than the first threshold, the second code rate is determined based on the number of bits of at least one of the first feedback information, the first scheduling request, the first channel state information or a first cyclic redundancy check in the first uplink control information, and based on the first number of resource elements for transmitting the first uplink control information in the first uplink control channel.

In some embodiments, when the number of bits of the first uplink control information is less than or equal to the first threshold, the second code rate is determined by (O_{HARQ-ACK}+O_{SR}+O_{CSI})/N_{RE}.

When the number of bits of the first uplink control information is greater than the first threshold, the second code rate is determined by (O_{HARQ-ACK}+O_{SR}+O_{CSI} O_{CRC})/N_{RE}.

Herein, O_{HARQ-ACK} is the number of bits of the first feedback information; SR is the number of bits of the first scheduling request; O_{CSI} is the number of bits of the first channel state information; N_{RE} is the first number; and O_{CRC} the number of bits of the first cyclic redundancy check.

In some embodiments, when the number of bits of the second uplink control information is less than or equal to a first threshold, the third code rate is determined based on the number of bits of at least one of second feedback information, a second scheduling request or second channel state information in the second uplink control information, and based on the second number of resource elements for transmitting the second uplink control information in the first uplink control channel.

When the number of bits of the second uplink control information is greater than the first threshold, the third code rate is determined based on the number of bits of at least one of the second feedback information, the second scheduling request, the second channel state information or a second cyclic redundancy check in the second uplink control information, and based on the second number of resource elements for transmitting the second uplink control information in the first uplink control channel.

In some embodiments, when the number of bits of the second uplink control information is less than or equal to the first threshold, the third code rate is determined based on (O_{HARQ-ACK}+O_{SR}+O_{CSI})/N_{RE}.

When the number of bits of the second uplink control information is greater than the first threshold, the third code rate is determined based on (O_{HARQ-ACK}+O_{SR}+O_{CSI}+O_{CRC})/N_{RE}.

Herein, O_{HARQ-ACK} is the number of bits of the second feedback information; O_{SR} is the number of bits of the second scheduling request; O_{CSI} is the number of bits of the second channel state information; N_{RE} is the second number; and O_{CRC} the number of bits of the second cyclic redundancy check.

In some embodiments, the second determination unit 402 is further configured to determine the power adjustment component based on the first code rate when a format of the first uplink control channel is format 2, format 3 or format 4.

In some embodiments, the second determination unit 402 is further configured to determine the power adjustment component based on 10*log₁₀(K₁*A) when the format of the first uplink control channel is format 2, format 3 or format 4 and the number of bits of the uplink control information on the first uplink control channel is less than or equal to a first threshold. Herein, K₁ is a first constant; A is the first code rate; and log represents a logarithmic function.

In some embodiments, the second determination unit 402 is further configured to determine the power adjustment component based on 10*log₁₀(2^{K}^{₂}^{*A}−1), when the format of the first uplink control channel is format 2, format 3 or format 4 and the number of bits of the uplink control information on the first uplink control channel is greater than a first threshold. Herein, K₂ is a second constant; A is the first code rate; and log represents a logarithmic function.

In some embodiments, the second determination unit 402 is further configured to determine the power adjustment component based on the number of symbols of the first uplink control channel and the number of bits of the uplink control information on the first uplink control channel, when a format of the first uplink control channel is format 0 or format 1.

In some embodiments, the second determination unit 402 is further configured to determine the power adjustment component based on

$$10 * {log}_{10} ( \frac{N}{M} + {Δ}_{UCI} ) .$$

Herein, M is the number of symbols of the first uplink control channel.

Herein, N is 2 when the format of the first uplink control channel is format 0; N is the number of symbols in a slot when the format of the first uplink control channel is format 1.

Herein, Δ_{UCI} is 0 when the format of the first uplink control channel is format 0; Δ_{UCI} is 10*log₁₀(O_{uci}) when the format of the first uplink control channel is format 1, where O_{uci} is the number of bits of the uplink control information on the first uplink control channel; log represents a logarithmic function.

It should be understood by those skilled in the art that the descriptions related to the terminal of the embodiments of the disclosure may be understood with reference to the descriptions related to the method for determining the power adjustment component of the embodiments of the disclosure.

FIG. 5 is a structural diagram of a terminal according to an embodiment of the disclosure. This terminal may be the above-mentioned terminal. The terminal 500 illustrated in FIG. 5 includes a processor 501 and a memory 502. The memory 502 stores a computer program executable on the processor 501. The processor 501 is configured to execute the computer program to perform the above method for determining a power adjustment component.

For example, the processor 501 executes the program to perform the following operations.

Multiple code rates are determined. The multiple code rates correspond to multiple uplink control information transmitted on a first uplink control channel. A power adjustment component of the first uplink control channel is determined based on a first code rate. The first code rate is determined based on at least one of the multiple code rates.

The memory 502 may be a separate device independent of the processor 501, or may be integrated in the processor 501.

In some embodiments, as illustrated in FIG. 5, the terminal 500 may further include a transceiver 503, and the processor 501 may control the transceiver 503 to communicate with another device, specifically, sending information or data to the other device or receiving information or data from the other device.

The transceiver 503 may include a transmitter and a receiver. The transceiver 1330 may further include an antenna. The number of the antenna may be one or more.

In some embodiments, the terminal 500 may specifically be a network device of the embodiments of the disclosure, and the terminal 500 may perform corresponding processes performed by the network device in each method of the embodiments of the disclosure. For simplicity, elaborations are omitted herein.

In some embodiments, the terminal 500 may specifically be a mobile terminal/terminal device of the embodiments of the disclosure, and the terminal 500 may perform corresponding processes performed by the mobile terminal/terminal device in each method of the embodiments of the disclosure. For simplicity, elaborations are omitted herein.

Embodiments of the disclosure may also provide a computer storage medium having stored thereon one or more programs that, when executed by one or more processors, cause the one or more processors to perform the method for determining a power adjustment component of any of the above embodiments.

For example, the one or more programs may be executed by one or more processors, to perform the following operations.

Multiple code rates are determined. The multiple code rates correspond to multiple uplink control information transmitted on a first uplink control channel. A power adjustment component of the first uplink control channel is determined based on a first code rate. The first code rate is determined based on at least one of the multiple code rates.

FIG. 6 is a structural diagram of a chip according to an embodiment of the disclosure. The chip 600 illustrated in FIG. 6 includes a processor 601, and processor 601 may call and run a computer program from a memory to perform the method in embodiments of the disclosure.

For example, the processor 601 may call and run a computer program from a memory to perform the following operations.

Multiple code rates are determined. The multiple code rates correspond to multiple uplink control information transmitted on a first uplink control channel. A power adjustment component of the first uplink control channel is determined based on a first code rate. The first code rate is determined based on at least one of the multiple code rates.

In some embodiments, as illustrated in FIG. 6, the chip 600 may further include a memory 602. The processor 601 may call and run the computer program in the memory 602 to perform the method in the embodiments of the disclosure.

The memory 602 may be a separate device independent of the processor 601, or may be integrated in the processor 601.

In some embodiments, the chip 600 may also include an input interface 603. The processor 601 may control the input interface 603 to communicate with other devices or chips; specifically, the input interface may acquire information or data sent by other devices or chips.

In some embodiments the chip 600 may further include an output interface 604. The processor 601 may control the output interface 604 to communicate with other devices or chips; specifically, the output interface may output information or data to other devices or chips.

In some embodiments, the chip may be applied to the network device of the embodiments of the disclosure, and the chip may perform corresponding flows performed by the network device in each method of the embodiments of the disclosure. For simplicity, elaborations are omitted herein.

In some embodiments, the chip may be applied to the mobile terminal/terminal device of the embodiments of the disclosure, and the chip may perform corresponding flows performed by the mobile terminal/terminal device in each method of the embodiments of the disclosure. For simplicity, elaborations are omitted herein.

It is to be understood that the chip mentioned in the embodiments of the disclosure may also be called a system-level chip, a system chip, a chip system or a system on chip, or the like.

Embodiments of the present disclosure may also provide a computer program product which includes a computer storage medium. The computer storage medium stores the computer programs which includes instructions that executable by at least one processor that, when executed by the at least one processor, to implement the method for determining a power adjustment component of any of the above embodiments.

For example, when the instruction is executed by the at least one processor, the following operations are performed.

Multiple code rates are determined. The multiple code rates correspond to multiple uplink control information transmitted on a first uplink control channel. A power adjustment component of the first uplink control channel is determined based on a first code rate. The first code rate is determined based on at least one of the multiple code rates.

Embodiments of the present disclosure may also provide a computer program that causes a computer to perform a method for determining a power adjustment component of any of the above embodiments.

For example, the computer program causes a computer to perform the following operations.

Multiple code rates are determined. The multiple code rates correspond to multiple uplink control information transmitted on a first uplink control channel. A power adjustment component of the first uplink control channel is determined based on a first code rate. The first code rate is determined based on at least one of the multiple code rates.

It should be noted that the above descriptions of terminals, the computer storage medium, the chip, the computer program product and the computer program embodiments are similar to those of the above method embodiments, and have similar beneficial effects as those of the method embodiments. Technical details not disclosed in terminals, the computer storage medium, the chip, the computer program product, and the computer program embodiments of the disclosure may be understood with reference to the description of method embodiments of the present disclosure.

It is to be understood that the processor or the chip in the embodiments of the disclosure may be an integrated circuit chip and has a signal processing capability. In an implementation process, each operation of the method embodiments may be completed by an integrated logical circuit of hardware in the processor or an instruction in a software form. The above processor or the chip may include integration of one or more of the followings: Application Specific Integrated Circuit (ASIC), Digital Signal Processor (DSP), Digital Signal Processing Device (DSPD), Programmable Logic Device (PLD), Field Programmable Gate Array (FPGA), Central Processing Unit (CPU), Graphics Processing Unit (GPU), neural-network processing units (NPU), Controller, Microcontroller, or Microprocessor. Each method, operation and logical block diagram disclosed in the embodiments of the disclosure may be implemented or executed. The general-purpose processor may be a microprocessor, or the general-purpose processor may be any conventional processor and the like. The operations of the method disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-only Memory (ROM), a Programmable ROM (PROM) or Electrically Erasable PROM (EEPROM) and a register. The storage medium is located in a memory, and the processor reads information from the memory, and completes the operations of the methods in combination with hardware.

It can be understood that the memory in the embodiment of the disclosure may be a volatile memory or a nonvolatile memory, or may include both the volatile and nonvolatile memories. The nonvolatile memory may be a ROM, a PROM, an Erasable PROM (EPROM), an EEPROM or a flash memory. The volatile memory may be a RAM, and is used as an external cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory of a system and method described in the disclosure is intended to include, but not limited to, memories of these and any other proper types.

It is to be understood that the memories above mentioned are exemplarily but unlimitedly described. For example, the memories in the embodiments of the disclosure may also be an SRAM, a DRAM, a SDRAM, a DDR SDRAM, an ESDRAM, a SLDRAM and a DR RAM and the like. That is, the memories in the embodiments of the present disclosure are intended to include, but not limited to, memories of these and any other proper types.

Those of ordinary skill in the art may realize that the units and algorithm operations of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that for specific working processes of the system, device and unit described above, the references may be made to the corresponding processes in the method embodiments and will not be elaborated herein for convenient and brief description.

In some embodiments provided by the disclosure, it is to be understood that the disclosed system, device and method may be implemented in the other manners. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, the couplings or direct couplings or communication connections displayed or discussed between each other may be indirect couplings or communication connections through some interfaces, apparatuses or units, and may be implemented in electric, mechanical, or other forms.

The units described as separate parts may or may not be physically separated, and parts displayed as units may or may not be physical units, may be located in one position, or may be distributed on multiple network units. Some or all of the units may be selected to achieve the objectives of the solutions of the embodiments according to actual requirement. In addition, each functional unit in each embodiment of the disclosure may be integrated into one processing unit, may physically exist independently, or two or more units may be integrated into one unit.

If implemented in form of software functional units and sold or used as an independent product, the functions may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including multiple instructions configured to enable a computer device (which may be a personal computer, a server, a network device or the like) to execute all or part of the operations of the method in each embodiment of the disclosure. The abovementioned storage medium includes various media capable of storing program codes, such as a universal serial bus (USB) flash disk, a mobile hard disk, a ROM, a RAM, a magnetic disk or an optical disk.

The above descriptions are only the specific implementations of the disclosure, but are not intended to limit the protection scope of the disclosure. Any variations or replacements apparent to those skilled in the art within the technical scope disclosed in the disclosure shall fall within the protection scope of the disclosure. Therefore, the protection scope of the disclosure shall be subject to the protection scope of the claims.

1. A method for determining a power adjustment component, comprising:
determining, by a terminal, the power adjustment component of a first uplink control channel based on a first code rate, wherein the first uplink control channel is used for transmitting a plurality of uplink control information, the plurality of uplink control information corresponding to a plurality of code rates, and the first code rate is determined based on at least one of the plurality of code rates.

2. The method of claim 1, wherein the plurality of uplink control information correspond to a plurality of priorities.

3. The method of claim 1, further comprising:
determining, by the terminal, a plurality of uplink control channels corresponding to the plurality of uplink control information; and
determining, by the terminal, to multiplex the plurality of uplink control information on the first uplink control channel for transmission, when each of the plurality of uplink control channels overlaps with at least one other uplink control channel of the plurality of uplink control channels in a time domain.

4. The method of claim 1, wherein the plurality of code rates comprise a second code rate and a third code rate, wherein the second code rate corresponds to first uplink control information transmitted on the first uplink control channel, and the third code rate corresponds to second uplink control information transmitted on the first uplink control channel.

5. The method of claim 4, wherein
the second code rate is determined based on a network configuration; or
the second code rate is determined based on a pre-configuration; or
the second code rate is determined based on a number of bits of the first uplink control information and a resource for transmitting the first uplink control information in the first uplink control channel; or
the second code rate is determined based on a code rate corresponding to a second uplink control channel for separately carrying the first uplink control information; or
the second code rate is determined based on a code rate corresponding to the first uplink control information when transmitted on the first uplink control channel.

6. The method of claim 1, wherein determining, by the terminal, the power adjustment component based on the first code rate comprises:
when a format of the first uplink control channel is format 2, format 3 or format 4, determining, by the terminal, the power adjustment component based on the first code rate.

7. The method of claim 6, wherein when the format of the first uplink control channel is format 2, format 3 or format 4, determining, by the terminal, the power adjustment component based on the first code rate comprises:
when the format of the first uplink control channel is format 2, format 3 or format 4, and a number of bits of the uplink control information on the first uplink control channel is less than or equal to a first threshold, determining the power adjustment component based on 10*log₁₀(K₁*A), wherein K₁ is a first constant; A is the first code rate; and log represents a logarithmic function;
when the format of the first uplink control channel is format 2, format 3 or format 4, and a number of bits of the uplink control information on the first uplink control channel is greater than a first threshold, determining the power adjustment component based on 10*log₁₀(2^{K}^{₂}^{*A}−1), wherein K₂ is a second constant; A is the first code rate; and log represents a logarithmic function.

8. The method of claim 1, further comprising:
when a format of the first uplink control channel is format 0 or format 1, determining, by the terminal, the power adjustment component based on a number of symbols of the first uplink control channel and a number of bits of the uplink control information on the first uplink control channel.

9. The method of claim 8, wherein determining, by the terminal, the power adjustment component based on the number of symbols of the first uplink control channel and the number of bits of the uplink control information on the first uplink control channel comprises:
determining, by the terminal, the power adjustment component based on
$$10 * {log}_{10} ( \frac{N}{M} + {Δ}_{UCI} ) ,$$
wherein M is the number of symbols of the first uplink control channel;
N is 2 when the format of the first uplink control channel is format 0, and N is a number of symbols in a slot when the format of the first uplink control channel is format 1;
Δ_{UCI} is 0 when the format of the first uplink control channel is format 0; and Δ_{UCI} is 10*log₁₀(O_{uci}) when the format of the first uplink control channel is format 1, wherein O_{uci} is the number of bits of the uplink control information on the first uplink control channel; and
log represents a logarithmic function.

10. A terminal, comprising:
a processor; and
a memory storing a computer program that, when executed by the processor, causes the processor to determine a power adjustment component of a first uplink control channel based on a first code rate, wherein the first uplink control channel is used for transmitting a plurality of uplink control information, the plurality of uplink control information corresponding to a plurality of code rates, and the first code rate is determined based on at least one of the plurality of code rates.

11. The terminal of claim 10, wherein the first code rate comprises at least one of:
any one of the plurality of code rates;
a lowest code rate of the plurality of code rates;
a highest code rate of the plurality of code rates;
an average of the plurality of code rates;
a mode of the plurality of code rates;
a median of the plurality of code rates;
a code rate of the plurality of code rates corresponding to uplink control information with a high priority; or
a code rate of the plurality of code rates corresponding to uplink control information with a low priority.

12. The terminal of claim 10, wherein the plurality of code rates comprise a second code rate and a third code rate, wherein the second code rate corresponds to first uplink control information transmitted on the first uplink control channel, and the third code rate corresponds to second uplink control information transmitted on the first uplink control channel.

13. The terminal of claim 12, wherein a priority of the first uplink control information is a first priority, and a priority of the second uplink control information is a second priority.

14. The terminal of claim 12, wherein
when a number of bits of the first uplink control information is less than or equal to a first threshold, the second code rate is determined based on a number of bits of at least one of first feedback information, a first scheduling request or first channel state information in the first uplink control information, and a first number of resource elements for transmitting the first uplink control information in the first uplink control channel;
when the number of bits of the first uplink control information is greater than the first threshold, the second code rate is determined based on a number of bits of at least one of the first feedback information, the first scheduling request, the first channel state information or a first cyclic redundancy check in the first uplink control information, and the first number of resource elements for transmitting the first uplink control information in the first uplink control channel.

15. The terminal of claim 14, wherein
when the number of bits of the first uplink control information is less than or equal to the first threshold, the second code rate is determined by (O_{HARQ-ACK}+O_{SR}+O_{CSI})/N_{RE};
when the number of bits of the first uplink control information is greater than the first threshold, the second code rate is determined by (O_{HARQ-ACK}+O_{SR}+O_{CSI}+O_{CRC})/N_{RE},
wherein O_{HARQ-ACK} is the number of bits of the first feedback information; O_{SR} is the number of bits of the first scheduling request; O_{CSI} is the number of bits of the first channel state information; N_{RE} is the first number; and O_{CRC} the number of bits of the first cyclic redundancy check.

16. The terminal of claim 10, wherein the processor is configured to:
when a format of the first uplink control channel is format 2, format 3 or format 4, determine the power adjustment component based on the first code rate.

17. The terminal of claim 16, wherein the processor is configured to:
when the format of the first uplink control channel is format 2, format 3 or format 4, and a number of bits of the uplink control information on the first uplink control channel is less than or equal to a first threshold, determine the power adjustment component based on 10*log₁₀(K₁*A), wherein K₁ is a first constant; A is the first code rate; and log represents a logarithmic function;
when the format of the first uplink control channel is format 2, format 3 or format 4, and a number of bits of the uplink control information on the first uplink control channel is greater than a first threshold, determine the power adjustment component based on 10*log₁₀(2^{K}^{₂}^{*A}−1), wherein K₂ is a second constant; A is the first code rate; and log represents a logarithmic function.

18. The terminal of claim 10, wherein the processor is configured to:
when a format of the first uplink control channel is format 0 or format 1, determine the power adjustment component based on a number of symbols of the first uplink control channel and a number of bits of the uplink control information on the first uplink control channel.

19. The terminal of claim 18, wherein the processor is configured to:
determine the power adjustment component based on
$$10 * {log}_{10} ( \frac{N}{M} + {Δ}_{UCI} ) ,$$
wherein M is the number of symbols of the first uplink control channel;
N is 2 when the format of the first uplink control channel is format 0, and N is a number of symbols in a slot when the format of the first uplink control channel is format 1;
Δ_{UCI} is 0 when the format of the first uplink control channel is format 0; and Δ_{UCI} is 10*log₁₀(O_{uci}) when the format of the first uplink control channel is format 1, wherein O_{uci} is the number of bits of the uplink control information on the first uplink control channel; and
log represents a logarithmic function.

20. A chip, comprising: a processor configured to call and run a computer program from a memory, to enable a terminal equipped with the chip to perform the following operations comprising:
determining a power adjustment component of a first uplink control channel based on a first code rate, wherein the first uplink control channel is used for transmitting a plurality of uplink control information, the plurality of uplink control information corresponding to a plurality of code rates, and the first code rate is determined based on at least one of the plurality of code rates.
